(19) United States
(12) Patent Application Publication
(10) Pub. No.: US 2006/0275581 A1
(43) Pub. Date: Dec. 7, 2006

(54) METHOD AND SYSTEM FOR RESTRICTING VIEWING AREA THROUGH A WINDOW DEVICE

(76) Inventor: Debra E. McAnder, Phoenix, AZ (US)

Correspondence Address: SNELL & WILMER, 400 EAST VAN BUREN, ONE ARIZONA CENTER, PHOENIX, AZ, 85004-2202, US

(21) Appl. No.: 11/276,335

(22) Filed: Feb. 24, 2006

Related U.S. Application Data
(60) Provisional application No. 60/656,054, filed on Feb. 24, 2005.

(51) Int. Cl. B32B 3/10

(52) U.S. Cl. 428/138

(57) ABSTRACT

A method and system for restricting a viewing area through a window device, such as that installed within a door, are provided. Such a method and system are configured to serve the dual purpose of maintaining both the passage of light through a window, while substantially restricting the viewing area through the window that subsequently serves to significantly increase privacy, and yet provide aesthetically pleasing appearance functions.

### CROSS-REFERENCE TO RELATED APPLICATIONS

This application claims priority to and benefit of U.S. Provisional Application No. 60/656,054, entitled “Method and System for Restricting Viewing Area through a Window Device”, and filed on Feb. 24, 2005.

### FIELD OF INVENTION

The present invention relates to viewing windows. More particularly, the present invention relates to a method and system for restricting the viewing area through a window.

### BACKGROUND OF THE INVENTION

Conventional windows (or windows housed within the frame of a door) typically require cover in order to preserve privacy. Shades, curtains, exterior awnings, or tints are commonly used and, although these typical window treatments provide some privacy, they can also significantly obscure, or eclipse, the source of light. Consumers are compelled to purchase traditional window treatments that are limited in their visual appeal and provide no venue for personal input or expression. In other words, the products available in the current market are significantly limited, generic, and uninspired. For example, after parking the car in a garage and entering a home, the first thing one might see is either A) an uninspiring wood door that is closed to conceal a laundry room or B) a washer and dryer when the door was left open to let in some light, with neither option being appealing.

What many of today's homeowners want are aesthetic options that are just on the outside of the traditional track. They are requesting innovative and individualized items be incorporated into their home's interior—something creative, but not crazy; unique, not ubiquitous; such as door and other window applications that let in light, but provide sufficient privacy.

### SUMMARY OF THE INVENTION

In accordance with various aspects of the present invention, a method and system for restricting a viewing area through a window device, such as that installed within a door, are provided. Such a method and system are configured to serve the dual purpose of maintaining both the passage of light through a window, while substantially restricting the viewing area through the window that subsequently serves to significantly increase privacy.

In accordance with an exemplary embodiment, a method and system have been created that results in a viewing application, such as a door having a single glass pane and configured to serve a dual purpose in an original and innovative way, e.g., upon completion of the exemplary process, a door can be designed that serves to both substantially obstruct an unwanted view without over-restricting the passage of light. The exemplary method and system can actively incorporate the participation of each user. For example, each user can select their own collection of quotes or other designs to be applied to their window application, e.g., a 2000 letter count in a standard 80″ door, and/or select from a body of fonts and colors, such that no two doors or other window applications need to be the same.

In accordance with an exemplary embodiment, high quality vinyl can be used to laser cut the letters/quotes and applied to the glass panel of the door. Upon successful completion of the application of quotes or other designs, in accordance with an exemplary embodiment, a second layer of high quality vinyl, for example that resembles sand blasted glass, can then be applied over the collection of quotes or other designs resulting in a door that allows light to filter through while the quotes serve to obscure the view and provide an element of engagement for the viewer.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1 illustrates an exemplary blank wood door with a glass viewing window in accordance with an exemplary embodiment of the present invention;

FIGS. 2A and 2B illustrate the layout process of cutting and pasting quotes within a viewing window;

FIG. 3 illustrates an exemplary viewing window installed within a door in accordance with an exemplary embodiment of the present invention;

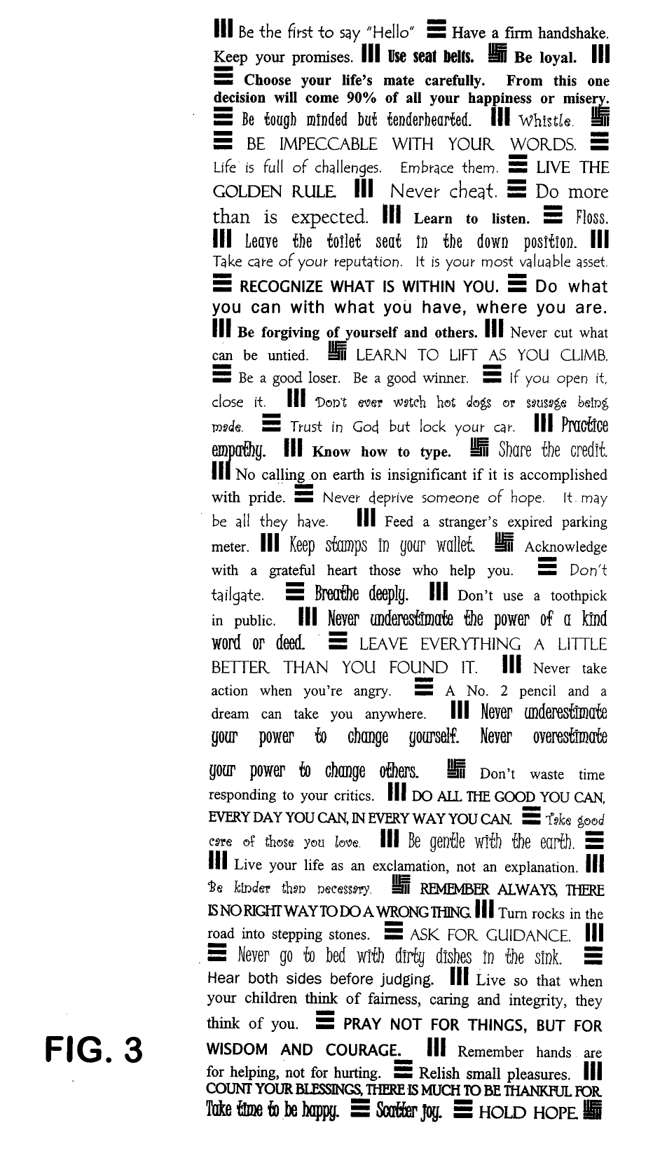

FIG. 4 illustrates an exemplary selection of colors for an exemplary door frame and wood insert for holding the viewing glass in place in accordance with an exemplary embodiment; and

FIG. 5 illustrates exemplary quotation layouts for viewing by a customer.

### DETAILED DESCRIPTION OF EXEMPLARY EMBODIMENTS OF THE INVENTION

The present invention may be described herein in terms of various functional components and various processing steps. It should be appreciated that such functional components may be realized by any number of hardware or structural components configured to perform the specified functions. For example, the present invention may employ various colors, adhesives, binders, wood, glass, plastics, vinyls and/or composites or other combinations thereof whose structure may be suitably configured for various intended purposes. In addition, the present invention may be practiced in any application where aesthetically pleasing, yet restricted viewing is desired, and the viewing doors illustrated herein are merely for exemplary purposes, as the invention can be applied to any viewing window application.

In accordance with various aspects of the present invention, a method and system for restricting a viewing area through a window device, such as that installed within a door, are provided. Such a method and system are configured to serve the dual purpose of maintaining both the passage of light through a window, while substantially restricting the viewing area through the window that subsequently serves to significantly increase privacy.

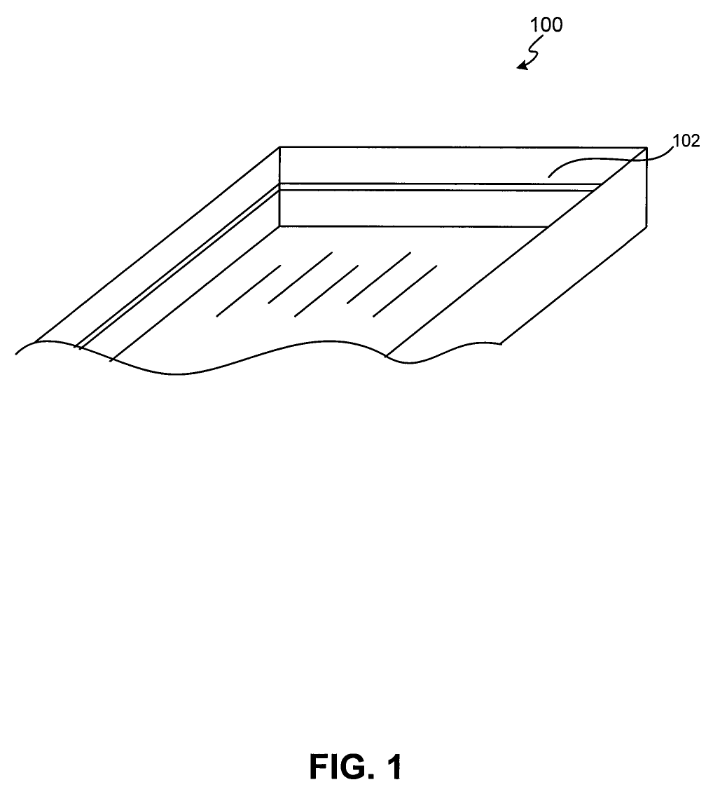

In accordance with an exemplary embodiment of the present invention, a method and system created for restricting the viewing area within a window such as, for example, a window device installed within a door, such as the exemplary door 100 having a viewing window 102 as illustrated in FIG. 1. In accordance with an exemplary embodiment, a primary structure of door 100 can comprise stain grain wood doors (both interior and exterior) with a solid pane of glass 102 in the center (e.g., one solid pane, however, two sheets of glass may also be selected, such as when the application comprises an exterior door). Door 100 and window 102 can comprise any configuration, size and shape for conventional doors available today or in the future.

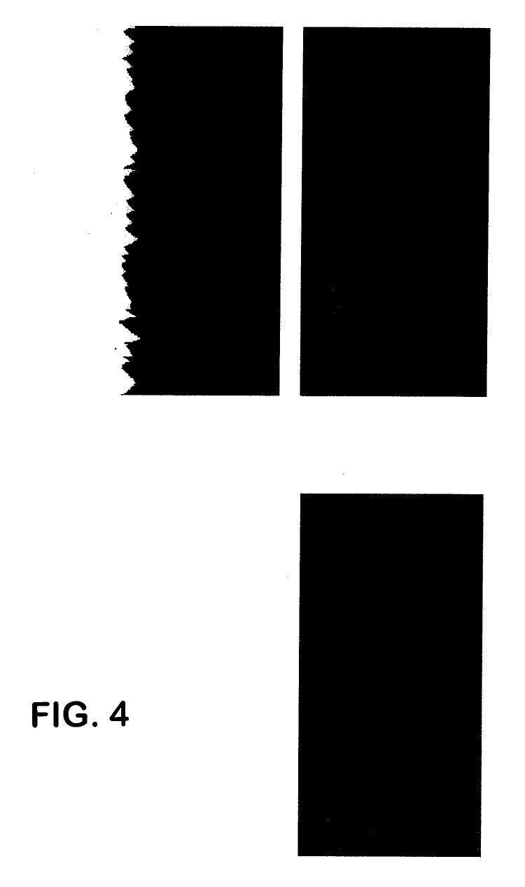

The exemplary method and system can actively incorporate the participation of each user. For example, door specifications (door and glass size) can be determined by the user. In addition, stain or paint color can be pre-determined by the user or consumer, who also have the option of painting his or her own door or having the door painted after completion. To facilitate the color combinations, various small samples of paint color combinations, such as one for door surface and one for small interior piece of wood that holds glass as illustrated in FIG. 4, can be provided for selection by the user, who can select from such various options, or choose their own, including.

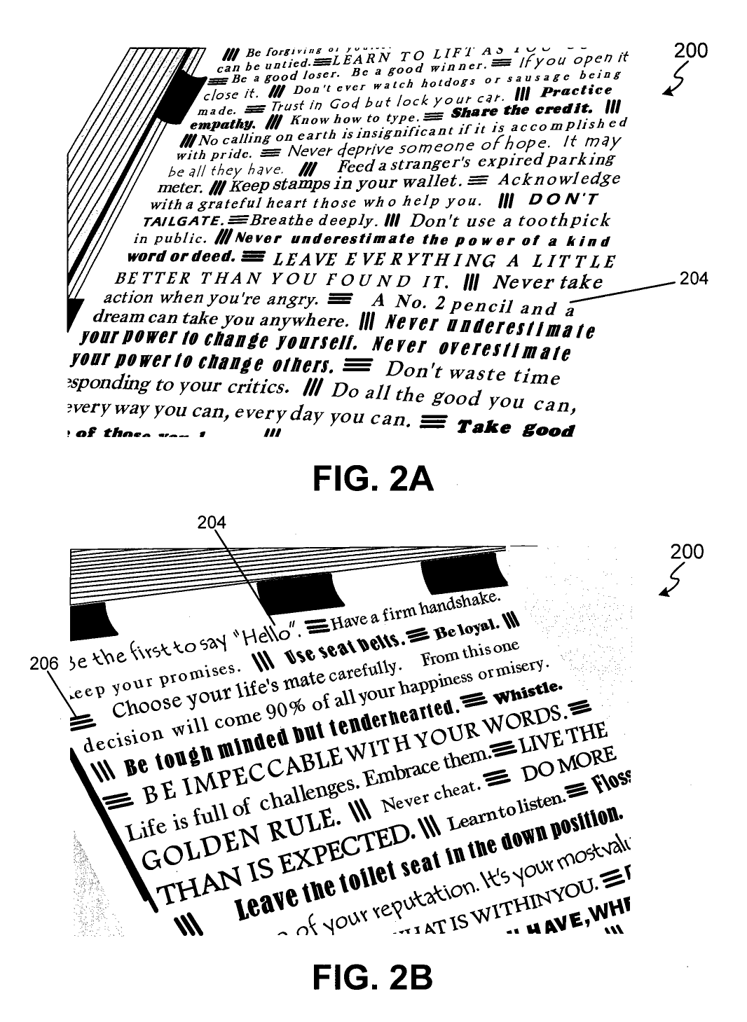

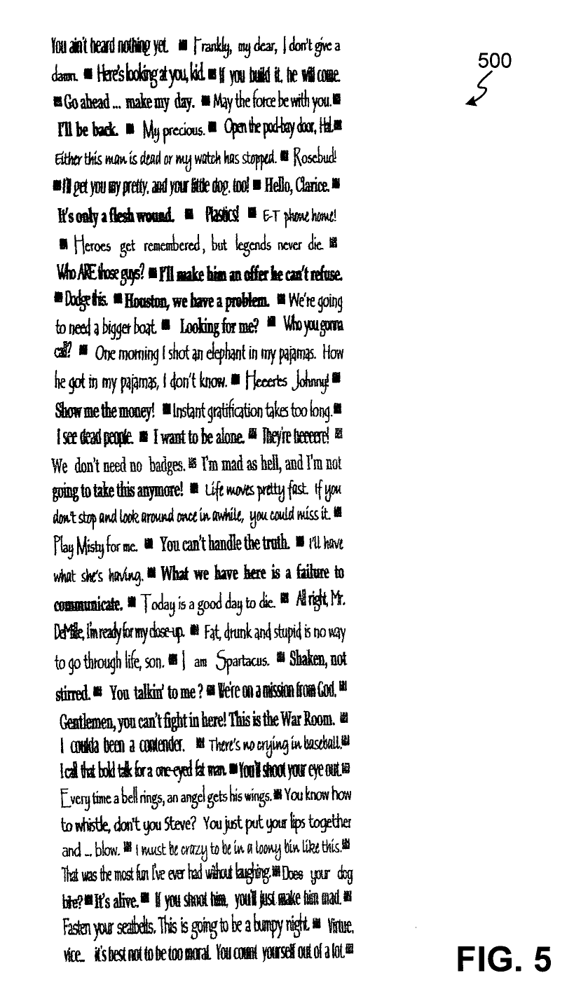

In accordance with an exemplary embodiment, after door specifications (door and glass size) are determined, an assortment of numerous fonts, for example approximately 25-30 fonts choices, can be provided, allowing the user to choose a few, e.g., seven to nine styles, and at least one font color. To assist in such selection, actual samples on glass can be provided, such as that illustrated in FIGS. 2A and 2B, that comprise text 204 and/or graphic elements 206, or from computer graphic or other digital displays. Text 204 and graphics 206 can comprise any configuration of text or graphics known or hereinafter devised. Any selected font styles and font color can then utilized to generate an exemplary layout using a computer graphic arts program, such as that illustrated in FIG. 5. In addition, each user can select their own collection of quotes or other designs to be applied to their window application, e.g., a 2000 letter count in a standard 80″ door, along with the selection from a body of fonts and colors, such that no two doors or other window applications need to be the same.

In accordance with an exemplary embodiment, a collection of quotes available from a variety of sources, such as the plethora of available web sites that house literally thousands of quotes, can be provided, with a goal of selecting a plurality sufficient to provide restricted viewing and yet sufficient light to pass through window 102. For example, users may select approximately 50 quotes for a standard 80″ door. Some of the quotes embedded in a door design can be original from the user, paraphrased, and/or well known. In accordance with an exemplary embodiment, a client can suitably select a “theme”—a pediatrician may want quotes related to kids and parenting, a door to a home movie theatre may have a collection of favorite movie quotes. Other embodiments may include a Biblical passage, a personal poem written by the user, and/or a collection of quotes related to “character” (integrity, intent, trustworthy, dependable, and the like), humorous (“Trust in God, but lock your car”) and others profound quotes (“Remember always, there is no right way to do a wrong thing”.) Users can select the quote they want to appear first and the quote they want to be last and everything else in between, or leave such placement in the hands of a professional with artistic talents that can make a suitably layout to accommodate visual flow, choice of fonts, “flow” of quotes from one to another, and the like.

To achieve the intended functions of restricting the viewing area and yet allowing light to pass through, the size and font styles are suitably selected, e.g., the total viewing area within a window may be reduced by 50%, 70% to 90% or more through the user of smaller or larger, or fewer or more characters or sizes and the like. In addition, the viewing restrictions also serve to dampen light, which tends to pass around and through openings in the letters or other openings within other design elements. The amount of light can be further enhanced or limited by suitably selecting the glass to comprise clear configurations to various shades of opaque or other like light or viewing filters or retardants designed to limit the passage of light. Thus, for example, while a customary door with clear glass would ordinarily allow essentially 100% light passage as well a viewing into a laundry room or office, use of selectively placed quotes and other graphics can suitably restrict and/or limit the ability to view through the window portion, while also allowing suitable light to pass through as desired. Moreover, the restricting components, e.g., the quotes and other design elements, can also serve to provide aesthetically pleasing configurations that can inspire or otherwise enhance the viewing appearance.

After completion of an initial draft (utilizing glass and door dimensions, font and quote selection and sequence of quotes), a user can review and provide for any edits at that time through use of an exemplary layout 500 as illustrated in FIG. 5, for example. To generate such a layout, an exemplary method and system can use a graphic design program (e.g., Adobe Illustrator) to layout and/or create a custom door that is transferred to a storage media, such as a disc or any other conventional media. The user can then determine a final approved layout for manufacture of the window/door application.

Such a disc or other storage media can be delivered to a local sign shop or other like graphics designer where modifications may be made in order to accommodate the specifications for the computer program that connects to a laser-cutting machine. Utilizing a laser cutting process (vs. sandblasting) creates an affordable price point for a larger number of homeowners and other consumers. Sandblasting dictates the thickness of the glass that makes many doors unaffordable. For example, in sandblasting a creation with such intensive text (approximately 2000 letters on a standard 80″ door), it can be exceedingly difficult to process the print. In addition, the thickness of the glass (and the glass in many interior doors) will not sustain the pressure of sandblasting (without shattering), and a door full of sandblasted quotes is visually difficult to read. However, in accordance with an exemplary embodiment, the application of laser cut vinyl letters and the subsequent application of a solid sheet of “sandblasted-looking” or other similar appearance-type vinyl can be utilized on interior doors with glass inserts as thin as approximately one-quarter inch (such as a standard door affordably sold at your local home improvement stores). In addition, the colored vinyl, coupled with the variety of fonts, can make the text, quote or designs much easier to read.

In accordance with an exemplary embodiment, high quality vinyl can be used to laser cut the letters/quotes and applied to the glass panel of the door. Such application can comprise any adhesive, bonding or other process for applying vinyls, plastics or other like materials onto glass that is now known or hereinafter devised. Upon successful completion of the application of quotes or other designs, in accordance with an exemplary embodiment, a second layer of high quality vinyl, for example that resembles sand blasted glass, can then be applied over the collection of quotes or other designs resulting in a door that allows light to filter through while the quotes serve to obscure the view and provide an element of engagement for the viewer.

Upon completion of the laser cutting, application of the quotes and other designs to the glass is the next step, which can comprise a methodical and time intensive process, often requiring the services of a professional. For example, the center of many, many letters of the alphabet (a, o, p, q, d, b . . . ) is gingerly pulled away from a letter's interior, and the backing which held the letters is carefully removed, and the window can be reviewed for any errors in application. In accordance with an exemplary embodiment, a second layer of vinyl can be applied. The second layer comprises a solid sheet of vinyl or like functioning material that is applied over the collection of quotes applied to the glass. In accordance with an exemplary embodiment, two or more levels of opaque density can be provided for a user to choose from, such as a sheet of vinyl that appears to be opaque or sand blasted. The laser cutting process and application of vinyl or like materials can comprise any conventional methodology for using such techniques on materials. Upon application of the second layer of vinyl or like material, or without use of such a second layer, a door application can be finally inspected and approved before delivery to the user for installation.

There are a number of benefits inherent in the exemplary window applications. For example, the innovative design process can actively incorporate the participation of each user, who can have a strong tendency to become authentically engaged in the creation of their door or other window application—they solicit input from family members, friends and fellow colleagues, pouring over quotes with delight as they narrow their list to the suitably number for application. Users also tend to carefully consider their font options and victoriously circle the final few, knowing that a specially created and unique door application will be obtained. In addition to the viewing restriction functions, an added benefit is the compilation of quotes or other design elements, e.g., that mounted in a contrasting, colored vinyl and incorporating a variety of fonts, can serve to engage visually (and cognitively) the viewer (as they read the collection of quotes) that serves to further distract a viewer from seeing what is behind the door.

In accordance with an exemplary embodiment, an exemplary method for providing such a viewing window can comprise the initial meeting with user to outline process and procedure,—and show a template or other examples of completed window applications. For example, a bank of font styles and colors can be provided such that the user can suitably choose their favorites. A collection of quotes or other design elements can also be offered, e.g., printed from a variety of sources in hard copy, compiled in a notebook or offer to generate a disc with quotes or other like options. The user can also collect a plurality of quotes, e.g., approximately 50-60 quotes or more, and can suitably identify a preferable order of layout, e.g., can select the first quote and last quotes that the user wants to appear on door, and/or any quotes in between. Prior to or after the selection of quotes, the door specifics can be determined—e.g., the colors, dimensions, and the like.

Once final quote or design elements selection are made, the quotes are compiled utilizing graphic software, such as for example, Adobe Illustrator and/or Word. Next, the order of presentation and select font for each quote are arranged to generate a preliminary design for review and identify any requested changes. Any finalized changes (as per user request) can be stored on a storage media and transferred to program for facilitating the laser cutting process and vinyl layer applications processes, including the visual and final inspections processes.

The present invention has been described above with reference to an exemplary embodiment. However, those skilled in the art will recognize that changes and modifications may be made to the exemplary embodiment without departing from the scope of the present invention. For example, the various components may be implemented in alternate ways, such as, for example, by installing on any window or other viewing device, or using various vinyl or other like composites or methods for filtering glass or other viewing windows, or reversing, modifying or repeating the various steps used in producing such windows, or any other like changes. These alternatives can be suitably selected depending upon the particular application or in consideration of any number of factors associated with the design of viewing windows for doors and other like applications. These and other changes or modifications are intended to be included within the scope of the present invention, as set forth within the following claims.

1. A method for restricting the viewing of objects through a glass window within a door, said method comprising:
selecting a plurality of design elements from a larger source of design elements;
laying out of said selected plurality of design elements in an arrangement configured to substantially cover the glass window such that a maximum viewing through the glass window is substantially restricted and yet a selected amount of light is allowed to pass through the glass window, and wherein said design elements provide an aesthetically pleasing appearance; and
applying said layout of selected plurality of design elements to the glass window.

2. The method according to claim 1, wherein said selecting of said plurality of design elements comprises selecting a plurality of quotes.

3. The method according to claim 2, wherein said selecting of a plurality of quotes is configured to generate a desired theme.

4. The method according to claim 2, wherein said selecting said plurality of design elements further comprises selecting a plurality of non-textual graphic elements configured to separate individual quotes.

5. The method according to claim 1, said laying out comprises covering the glass window to limit the viewing through the glass window to less than 30% of the maximum viewing.

6. The method according to claim 5, said laying out comprises covering the glass window to limit the viewing through the glass window to less than 15% of the maximum viewing.

7. The method according to claim 1, wherein said applying the layout comprises applying a layer of vinyl onto the glass window and then laser-cutting the design elements in said layer to provide an appearance of said design elements onto the glass door.

8. The method according to claim 7, wherein said applying the layout further comprises applying a second layer of vinyl on top of said design elements to provide further filtering of light passing through the glass window.

9. A system for restricting the viewing of objects through a glass window of a door, said system comprising:
a laser-cutting device;
a vinyl layer applied to the glass window;
a plurality of design elements selected from a larger group of design elements; and
wherein said plurality of design elements are configured in a layout configured to substantially cover the glass window such that a maximum viewing through the glass window is substantially restricted and yet a selected amount of light is allowed to pass through the glass window, and wherein said design elements provide an aesthetically pleasing appearance, and wherein said layout is laser-cut into said vinyl layer by said laser-cutting device.

10. The system according to claim 9, wherein said plurality of design elements comprises a plurality of quotes configured to generate a desired theme and a plurality of non-textual graphic elements configured to separate individual quotes, and wherein said layout is configured to limit a viewing through the glass window to less than 30% of a maximum viewing.
